(19) United States
(12) Patent Application Publication
(10) Pub. No.: US 2023/0258791 A1
(43) Pub. Date: Aug. 17, 2023

(54) LANE ALIGNMENT DETECTION METHOD BASED ON MILLIMETER WAVE RADAR DATA

(71) Applicant: Tongji University, Shanghai (CN)

(72) Inventors: Junhua WANG, Shanghai (CN); Hao SONG, Shanghai (CN); Ting FU, Shanghai (CN)

(21) Appl. No.: 17/624,254

(22) PCT Filed: Oct. 12, 2021
(86) PCT No.: PCT/CN2021/123242

§ 371 Date: Dec. 30, 2021

(30) Foreign Application Priority Data
Oct. 29, 2020 (CN) 202011179544.0

(51) Int. Cl. G01S 13/58; G01S 13/52; G01S 13/44

(52) U.S. Cl. CPC G01S 13/58; G01S 13/52; G01S 13/4418

(57) ABSTRACT

The present disclosure discloses a method for lane alignment detection based on millimeter wave radar data. An embodiment of the method comprises: acquiring the vehicle trajectory data and radar reflection data detected by the millimeter wave radar which are installed on the road to sense the moving vehicles; setting up two datasets in the database, including vehicle track dataset and waypoint dataset obtained after rasterizing the road; filtering vehicle track data and vehicle radar reflection data detected by millimeter-wave radar and eliminate erroneous data; performing radial clustering and horizontal initial stable point clustering on the filtered data; extracting and outputting the lane alignment. Compared with the prior art, the invention possesses the advantages of obtaining more accurate lane alignments, low cost and good adaptability, etc.

### BACKGROUND OF THE INVENTION

### 1. Field of the Invention

The invention relates to the technical field of big data application, in particular to a lane alignment detection method based on millimeter wave radar data.

### 2. Description of the Related Art

With the gradual reduction in the hardware cost of millimeter wave radars, some military high-precision millimeter wave radars are gradually open sourced to the civilian field. The application of millimeter wave radar in the transportation field is gradually expanding. Therefore, the collection and analysis of vehicle track information in the road area can be carried out based on the data of millimeter wave radar. In the era of big data, due to the huge amount of vehicle track data, the traffic track data can statistically reflect the lane alignment. The lane alignment is a manifestation of one of the basic attributes of the road itself, and is an important prerequisite for subsequent related research. Therefore, indirect detection of lane alignment through millimeter wave radar becomes a feasible solution. The current detection on lane alignment is mainly analyzing the actual photos. At the road section where the millimeter wave radar is the main sensor, extracting the lane alignment by conventional photos certainly will bring extra economic cost, such as installing the video equipment, secondary research and debugging based on photos and track data, etc. Additionally, it may also bring a series of problems such as the data docking of the two devices.

Moreover, the existing lane alignment detection methods all rely on video images for secondary development and recognition, without non-visual linear detection method. For the road sections with millimeter wave radar as the main sensor, adopting cameras to detect the lane alignment requires secondary development and data docking with the radar to match the lane data with the vehicle data obtained by the millimeter wave radar, which has poor adaptability and high cost.

### SUMMARY OF THE INVENTION

The purpose of the invention is to overcome the above defects of the prior art and provide a lane alignment detection method based on millimeter wave radar data. The method makes full use of the data returned by the millimeter wave radar, which realizes the lane alignment perception in a statistical sense, and obtains more accurate lane alignment s.

The purpose of the invention can be realized by the following technical solutions:

Compared with the prior art, the lane alignment detection method based on millimeter wave radar data of the invention at least includes the following advantageous effects:

1. The data used in the method of the invention to detect lane alignments is collected by the roadside fixed millimeter wave radar detection equipment. Historical radar data and real-time radar data are used, which has the characteristics of high detection accuracy and fast detection speed and fills the gap in the field of lane alignment detection in the field of using millimeter wave radar to collect vehicle tracks.

2. The method of combining horizontal clustering and radial clustering is used to determine lane alignments. The horizontal clustering determines the number of lanes according to the vehicle track and uses this as the reference point for subsequent radial clustering. Radial clustering is based on a stable horizontal reference point and performs radial extension to obtain more accurate lane alignments.

3. In the clustering algorithm, horizontal clustering is used to determine the number of stable lanes, which can avoid the problem that few traffic brings few track points, therefore causes the lack of clustering categories caused by outliers, and ultimately leads to lane alignment extraction error.

4. In the process of radial clustering, the lane alignment is corrected by the statistical analysis module, which can effectively avoid the unevenness of the driving track and the problem of uneven or deviation in the radial clustering points of the extracted lane alignment.

5. The invention eliminates the erroneous data contained in the vehicle's radar detection track data. And by judging the continuity of reflection data, it eliminates the loss of track data or abnormal data fields caused by data loss, reflection area occlusion between two adjacent vehicles, positioning failure, network transmission error, static object reflection noise, etc., which can make the data more precise, and is conducive to getting more accurate lane alignments.

6. It only needs to accurately determine the lane alignments of the road based on the data obtained by the millimeter wave radar, which requires low cost. Furthermore, it can well match the lane data with the traffic data obtained by the millimeter wave radar, with higher adaptability.

### BRIEF DESCRIPTION OF THE DRAWINGS

FIG. 1 is a schematic diagram of the installation method and sensing range of the millimeter wave radar in the lane alignment detection method based on millimeter wave radar data in the embodiment;

FIG. 2 is a schematic flowchart of a lane alignment detection method based on millimeter wave radar data in the embodiment.

### DETAILED DESCRIPTION OF THE PREFERRED EMBODIMENTS

The invention is further described in detail hereinafter with reference to the drawings and embodiments. Obviously, the described embodiments are a part of the embodiments of the invention, rather than all the embodiments. Based on the embodiments of the invention, all other embodiments obtained by those of ordinary skill in the art without creative work shall fall within the protection scope of the invention.

### EMBODIMENT

The invention relates to a lane alignment detection method based on millimeter wave radar data, which can make full use of the data returned from the millimeter wave radar, and statistically realize the lane alignment perception. The method comprises the following steps:

First, use the millimeter wave radar installed on the traffic road to sense the moving vehicles, and obtain the vehicle track data and vehicle radar reflection data detected by the millimeter wave radar.

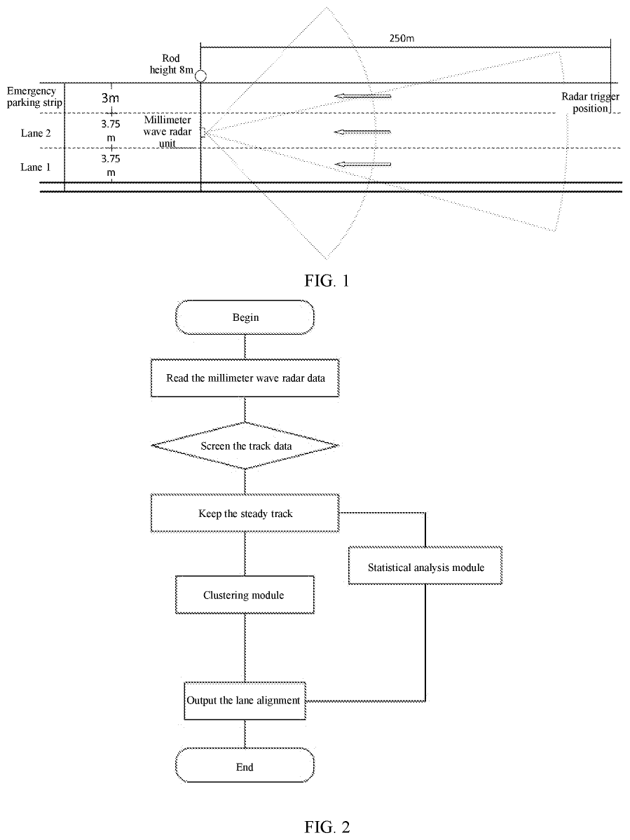

The millimeter wave radar can detect and sense the position of objects within a certain distance range by installing it on a rod of a certain height while tilting appropriately. In this embodiment, the installation method and sensing range of the millimeter wave radar are shown in FIG. 1. For three-lane, including lane 1, lane 2 and emergency stop strip, set a certain height of crossbars on both sides of the road, install the millimeter wave radar in the center of the crossbar to detect the position and speed of the vehicle on the lane. When the width of lane 1 and lane 2 is 3.75 m, the width of the emergency stop zone is 3 m, and the pole height is 8 m, the millimeter wave radar can be used to obtain the length of 250 m, which exceeds the detection range of the overall road width.

The fields of vehicle track data detected by millimeter-wave radar include: vehicle ID, time stamp, radial coordinates of the vehicle relative to the radar, tangential coordinates of the vehicle relative to the radar, radial component of the vehicle speed, and tangential component of the vehicle speed. The vehicle radar reflection data includes the radar reflection area, the latitude and longitude of the track point, the average speed corresponding to the track point, and the direction recognition track data. At the same time, establish two sets of datasets in the database, one is trace, the vehicle track dataset, and the other is roadpoint, the waypoint dataset obtained after the road is rasterized. The average speed corresponding to the track point refers to the average speed of the track segment composed of the track point and the previous one.

In this embodiment, the vehicle track data detected by the millimeter wave radar is read through the track reading algorithm. This data uses historical data and real-time input data as input data, which is convenient for quickly enabling lane alignment extraction. And it can continuously adjust to reduce the data error caused by the vibration of the detection equipment caused by road traffic, wind and other factors during the operation of the radar equipment, and obtain the radar time-series data.

Then establish a track data screening module to perform preliminary data quality screening and read the radar data detected by the millimeter wave radar equipment. The track data screening module recognizes the erroneous data contained in the track data according to the reflection area in the vehicle radar reflection data, the latitude and longitude of the track point, and/or the average speed and direction corresponding to the track point, and eliminates track data missing or abnormal data fields caused by data loss, reflection area occlusion between two adjacent vehicles, positioning failure, network transmission error, static object reflection noise, etc., specifically:

Judge the radar reflection area, and eliminate the reflection data with a width exceeds 5 meters and length exceeds 25 meters. Because the objects with the reflection area wider than 5 meters and longer than 25 meters must not be a vehicle, it is likely to be a large area of green plants, guardrails and attached sign billboards.

According to the longitude and latitude of the track point and/or the average speed corresponding to the track point in the vehicle track data detected by the millimeter wave radar, the erroneous track contained in the track data is identified. To identify whether a certain track point is an erroneous track point, it is necessary to analyze not only the latitude and longitude and or average speed of the track point itself, but also the latitude and longitude and or average speed of the adjacent track point or adjacent track segment. When the latitude and longitude of the track point exceeds the position range of adjacent track points in the same timestamp, or when the latitude and longitude of the track point exceeds the position range of adjacent timestamp track points, or when the average speed of the track point differs from the speed of the adjacent track points with the same time stamp by more than 5 m/s, it is also likely to be considered as the erroneous track point. Radar reflection data also includes reflection time. The radar reflection data also includes the reflection time. By acquiring the reflection time, the time stamp of the frame data is obtained. Define the frame by the acquired reflection time, each reflection time corresponds to a timestamp, which is a frame.

After removing the erroneous data, judge the continuity of the vehicle radar reflection data. Since the pointer of the radar data is recycled, it is necessary to distinguish objects with the same pointer. For objects with the same pointer (meaning the radar data ID corresponds to the same object), if there are discontinuous occurrences in different frames, it is judged as a different vehicle.

Perform cluster analysis on the cleaned data, extract and output the lane alignment. The clustering module is divided into horizontal clustering and radial clustering (horizontal refers to the direction parallel to the cross section of the road, and radial refers to the direction parallel to the lane alignment). Horizontal clustering is to perform horizontal initial stable point clustering, which aims to to first determine the number of lanes according to the vehicle track, and use this as a reference point for obtaining the line of this lane. Horizontal clustering is located at the cross section of the midpoint section of the millimeter wave radar equipment detection data retention section, and obtains the continuous center line of each lane of the road. The purpose of radial clustering is to extend radially based on the stable horizontal reference point, so as to determine the line line. Radial clustering is to cluster all track points, specifically:

Perform segmental clustering on all cleaned track points. In this embodiment, the vehicle track of a certain road section obtained by the millimeter wave radar is divided into several sections by 0.3 meters, and each section of the track is clustered according to the euclidean distance. The average coordinate point of all the track points of each track section is obtained as the virtual geometric center of each track (X_{Ti}, Y_{Ti}).

Take the cluster center coordinates (X_{T0}, Y_{T0}) of the first detected road section of the millimeter wave radar as the center (also used as the initial stable point of radial clustering), build a road raster network, and put it into the roadpoint dataset. The raster unit size is 0.1 m×0.1 m, and select the raster point (X_{Ri}, Y_{Ri}) closest to (X_{Ti}, Y_{Ti}) in the roadpoint dataset.

Radially connect a series of points (X_{Ri}, Y_{Ri}), which is the (X_{Ri}, Y_{Ri}) points of each road section, and smoothing process them to obtain a continuous road center line as the basis of the road line.

Horizontal clustering is to obtain the alignment of each lane. Specifically, horizontal clustering is clustered by lane based on millimeter wave radar. Perform horizontal initial stable point clustering for each track, and determine the horizontal clustering method according to the number of on-site road lanes. If it is three lanes, cluster the track points horizontally into three points, repeat the above steps to obtain the continuous center line of each lane of the road. Obtain the line of the entire road section according to the continuous center line. The radial clustering of the invention is to obtain the center point of the entire road section, and the horizontal clustering is to obtain the center point of each lane of the road section. One is to obtain the line of the entire road section, and the other is to obtain the line of each lane. Horizontal clustering obtains the center point of each lane of the road section, and then the width corresponding to each lane, and further obtains the lane alignment according to the width of each lane. The radial clustering can obtain the line of the entire road section, and then determine the lane direction. Combining the line of each lane, lane width and lane direction, the actual lane alignment of the road section can be determined and obtained.

Both horizontal clustering and radial clustering need steps of several times of clustering, and the point obtained by the first clustering is called the initial stable point.

In order to avoid the problem of inaccurate clustering or missing cluster categories due to the selection of the initial stable points of the cluster in the process of horizontal initial stable point clustering, the invention first uses a special single-point sensitive clustering method to determine the initial stable point as a reference point for subsequent acquisition of the lane alignment. The initial stable point is the center point of the entire road section. The first point obtained by clustering must be the reference point for subsequent clustering, and is also the initial stable point. Because the number of vehicles in some lanes is much smaller than other lanes (such as truck lanes), for lanes with few vehicle tracks, in order to avoid the track points being too few and ignored during clustering, it is necessary to adopt a clustering method that is sensitive to the clustering of a small number of points. That is, the initial stable point is determined for the single-point sensitive clustering method, and the determined initial stable point represents the number of stable lanes, which ensures the accuracy and stability of the subsequent acquisition of the lane alignment, thereby improving the stability of the calculation of the method of the invention.

In the method of radial clustering, since the lane alignment itself conforms to the continuity and the linear setting of the flat curve on the plane, in the clustering process, the longitudinal track points of each lane are clustered. In order to avoid the unevenness or deviation of the radial cluster points of the extracted lane alignments caused by the uneven driving track, the statistical analysis module is used to correct the driving track. It is mainly based on the statistical results of the interval track to calculate the deflection angle of the vehicle in this process, so as to correct the lane alignment. The statistical result of the section track is to average the tangential angles of all tracks of the road section, and use the average value as the vehicle deflection angle, and the vehicle deflection angle as the lane alignment deflection angle of the road section.

After the above steps, output the complete detection range lane alignment. And through the continuous input of data, the above method and process are repeated, so as to continuously adjust and output the lane alignment

The above are only specific embodiments of the invention, but the scope of protection of the invention is not limited thereto. Any person familiar with the technical field can easily think of various equivalent modifications or substitutions within the technical scope disclosed by the invention, and these modifications or substitutions shall all fall within the protection scope of the invention. Therefore, the protection scope of the invention should be subject to the protection scope of the claims.

1. A lane alignment detection method based on millimeter wave radar data, comprising the following steps:
1) use the millimeter wave radar installed on the road to sense the moving vehicles, and obtain the vehicle trajectory data and vehicle radar reflection data detected by the millimeter wave radar;
2) set up two datasets in the database, comprising vehicle track dataset and waypoint dataset obtained after rasterizing the road;
3) filter vehicle track data and vehicle radar reflection data detected by millimeter-wave radar and eliminate erroneous data;
4) perform horizontal clustering and radial clustering on the filtered data respectively, then extract and output the lane alignment by combining the results of horizontal clustering and radial clustering.

2. The lane alignment detection method based on millimeter wave radar data according to claim 1, wherein the vehicle track data detected by the millimeter wave radar comprises vehicle ID, timestamp, radial coordinates of the vehicle relative to the radar, tangential coordinates of the vehicle relative to the radar, radial and tangential component of vehicle speed.

3. The lane alignment detection method based on millimeter wave radar data according to claim 1, wherein the radar reflection data comprises radar reflection area, latitude and longitude of track point, average speed corresponding to the track point and orientation recognition track data.

4. The lane alignment detection method based on millimeter wave radar data according to claim 3, wherein the specific content of eliminating the erroneous data from the vehicle radar reflection data in step 3 is:
determine the radar reflection area and eliminate the reflection data of the radar reflection area with a width of more than 5 meters and a length of more than 25 meters;
determine the erroneous reflection data according to whether the latitude and longitude of the track point is between the two adjacent timestamp positions, if it exceeds the position range of the adjacent timestamp, the track point is judged as erroneous; otherwise, according to whether the average speed of the track point differs too much from the corresponding speed of the two adjacent timestamps, if the difference is too large, the track point is judged as erroneous.

5. The lane alignment detection method based on millimeter wave radar data according to claim 1, wherein specific content of the horizontal clustering in step 4 is:
determine a horizontal clustering method according to the number of the on-site road lanes, horizontally cluster the track points of the vehicle track in a certain road section; if the on-site road is three-lane, then horizontally cluster the track points into three points, if the on-site road is two-lane, then horizontally cluster the track points into two points; repeat this step to obtain the continuous center line of each lane of the road, then obtain the alignment of the entire road section according to the continuous center line.

6. The lane alignment detection method based on millimeter wave radar data according to claim 5, wherein the specific content of the radial clustering in step 4 is:
segment the vehicle track of a certain road section detected by the millimeter wave radar after eliminating the erroneous data at intervals, then separately cluster the track points of each track, and obtain the average coordinate of all track points of each track, as the virtual geometric center (X_{Ti}, Y_{Ti}) of each track; with (X_{T0}, Y_{T0}) as the center, build a road raster network and store it in the roadpoint dataset, then select the raster point (X_{Ri}, Y_{Ri}) closest to (X_{Ti}, Y_{Ti}) in the roadpoint dataset; radially connect a series of (X_{Ri}, Y_{Ri}) points and smoothing process them to obtain continuous road center line as the basis of road line.

7. The lane alignment detection method based on millimeter wave radar data according to claim 5, wherein the horizontal clustering adopts single-point sensitive clustering method to determine the initial stable point of the first clustering.

8. The lane alignment detection method based on millimeter wave radar data according to claim 6, wherein through the horizontal clustering, first obtain the center point of each lane of a certain road section, then obtain the corresponding lane width of each lane, and then obtain the line of each lane according to the lane width; after the radial clustering to obtain the line of the whole road section, determine the direction of the lanes, then combine the line, width and direction of each lane to determine the actual lane alignment of the road section.

9. The lane alignment detection method based on millimeter wave radar data according to claim 6, wherein the radial clustering process is provided with statistical analysis correction steps: calculate the deflection angle of the vehicle in the process according to the statistical results of the interval track, so as to correct the lane alignments.

10. The lane alignment detection method based on millimeter wave radar data according to claim 3, wherein a step of judging the continuity of vehicle radar reflection data is after step 3: judge objects with the same pointer in millimeter wave radar data, if the object appears discontinuously in different frames, it will be judged as another vehicle.
